(19) United States
(12) Patent Application Publication
(10) Pub. No.: US 2013/0307226 A1
(43) Pub. Date: Nov. 21, 2013

(54) SEALING SYSTEM

(71) Applicants: Roger Maurice Aspen, Hastings, NE (US); Jack Allen Schreiner, Hastings, NE (US); HAJIME ISHII, YOKOHAMA (JP)

(72) Inventors: Roger Maurice Aspen, Hastings, NE (US); Jack Allen Schreiner, Hastings, NE (US); HAJIME ISHII, YOKOHAMA (JP)

(73) Assignee: NISHIYAMA CORPORATION OF AMERICA, Great Neck, NY (US)

(21) Appl. No.: 13/473,446

(22) Filed: May 16, 2012

(51) Int. Cl. H02G 15/013; B23P 11/00; F16J 15/02

(52) U.S. Cl. 277/616; 277/650; 29/428

(57) ABSTRACT

At least one embodiment relates to a sealing system comprising a first end bracket, a second end bracket, a plurality of sections disposed between the first end bracket and the second end bracket. At least one section comprises three sections comprising a first sealing element a second sealing element, and a third sealing element. The first sealing element has a first hardness, the second sealing element has a second hardness, the third sealing element has a hardness different than the second sealing element hardness. The second sealing element has a larger radius than the first sealing element.

### BACKGROUND OF THE INVENTION

At least one embodiment of the invention relates to a sealing system for a channel which is configured to house wires or other related elements. With power stations and other types of industrial sites, there is a need to pass electrical cabling and wiring or any other type of cabling into, and out of these sites. Traditionally, this type of cabling was passed through a tube or other types of cylinders that form the passage into these sites. However, this too could also form an entranceway for other foreign objects such as water, animals or other external environmental objects which could pose harm to that site.

Therefore, there is a need for a sealing system which closes off a tube while still securing and allowing cable and pass there through.

### SUMMARY OF THE INVENTION

At least one embodiment of the invention is a securing system which is configured to fit inside of a channel or to which provide access to a site such as an industrial site.

In at least one embodiment of the invention, the sealing system is configured to be compressed and therefore, expand laterally to the walls of a pipe, channel, tube or cylinder to seal the walls of the pipe, channel, tube or cylinder against ingress or egress of materials to and from the site.

Therefore, at least one embodiment of the invention relates to a sealing system comprising a plurality of sections which can be assembled together with each section comprising any one of a first end bracket, a second end bracket, and a plurality of sealing elements disposed between the first end bracket and the second end bracket. The plurality of sealing elements can comprise three different sealing elements stacked adjacent to each other. The first sealing element has a first hardness, the second sealing element has a second hardness, and the third sealing element has a third hardness that is different than the hardness of the second section. In at least one embodiment, the second sealing element, which is the middle or inner sealing element, has a larger radius than the first sealing element or layer.

In at least one embodiment, the second layer or element has a larger radius than the third layer or element.

In at least one embodiment, the second element has at least two sides with a first side positioned adjacent to the first section and a second side positioned adjacent to the third section, wherein the first side has at least one indented portion configured to receive a protrusion on the first sealing element.

In at least one embodiment, the first section and the second section have a hardness ratio of approximately 1.5 to 1.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1A shows an end view of the sealing system;

FIG. 1B shows an opposite end view of the sealing system;

FIG. 1C is a side view of the sealing system installed into a pipe;

FIG. 2A shows a side view of the sealing systems shown in FIG. 1A with a nut removed;

FIG. 2B shows a partially unassembled version of the sealing system shown in FIG. 1A;

FIG. 3A shows an end view of the nut used in the design of FIG. 2A;

FIG. 3B shows a side cross-sectional view of the nut;

FIG. 3C is a side view of the nut used in the design of FIG. 2A;

FIG. 4A shows an exploded view side cross-sectional view of an assembly of a section of the sealing system;

FIG. 4B shows a close up view of the intersection of the outer sealing element with an inner sealing element;

FIG. 4C shows an exploded side view of a section of the sealing system;

FIG. 4D shows an exploded side view of another section of the sealing system;

FIG. 5A shows a side cross sectional view of an assembled section of the sealing system;

FIG. 5B shows a side view of an assembled section of the sealing system showing hidden lines or passages;

FIG. 5C shows a side view of this assembled sealing system;

FIG. 5D shows a side view of another embodiment of an assembled section of the sealing system showing hidden lines;

FIG. 6 shows a perspective exploded view of a section of the sealing system;

FIG. 7A shows a side cross-sectional view of a partial section of the sealing system;

FIG. 7B shows a side view of the partial section shown in FIG. 7A;

FIG. 7C shows an opposite side view of this partial section;

FIG. 7D shows an end view of this partial section shown in FIG. 7A;

FIG. 8A shows an end view of another partial section;

FIG. 8B shows an end view of another partial section;

FIG. 8C shows a side cross-sectional view of the partial section shown in FIG. 8A taken along the line B-B;

FIG. 8D shows an inner side view of the partial section shown in FIG. 8B; and

FIG. 8E shows an outer side view of the partial section shown in FIG. 8B.

### DETAILED DESCRIPTION OF PREFERRED EMBODIMENTS

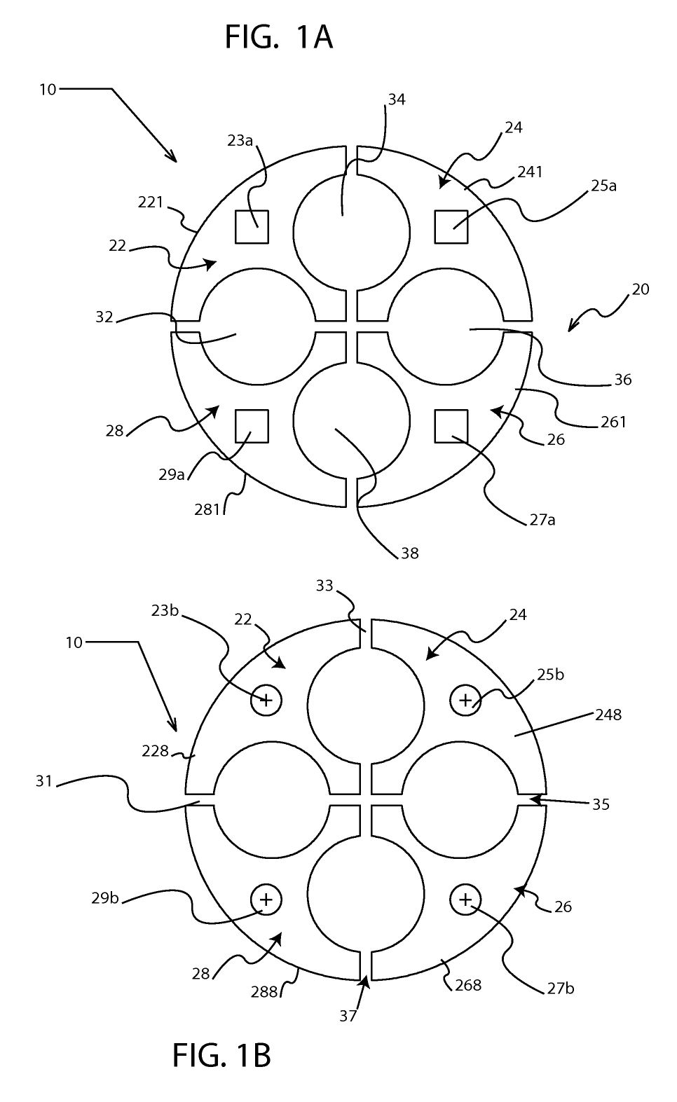

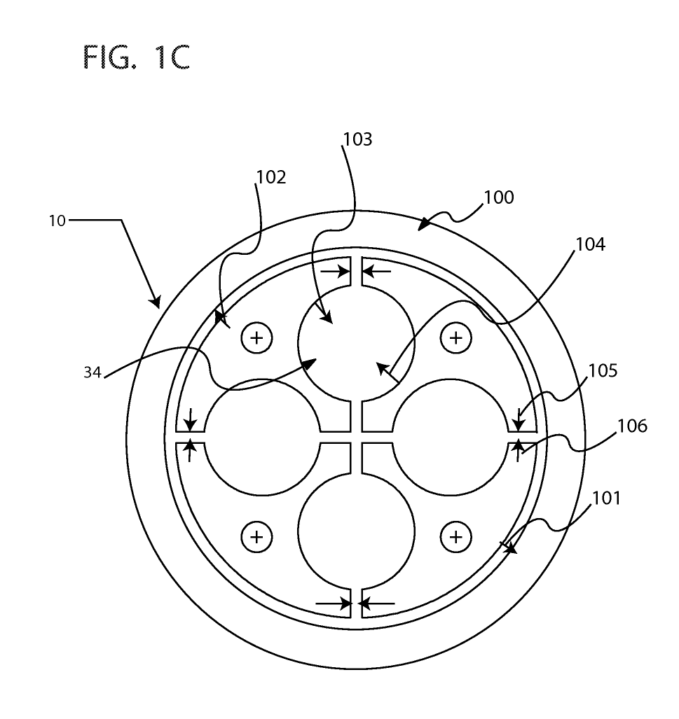

Turning now in detail to the drawings, FIG. 1A shows an end view of the sealing system. The sealing system in this end view is configured to be installed into a pipe such as a cylindrical pipe (See FIG. 1C). FIG. 1B shows an opposite end view of this sealing system. Sealing system 10 includes a plurality of different sections 20 including individual sections 22, 24, 26, and 28. Each section is approximately ¼ of a full circle, or a 90 degree section around a cylinder. In FIG. 1A, a plurality of metal end plates 221, 241, 261, and 281 are shown for each section. These metal end plates can be made from any suitable metal such as, but not limited to stainless steel, iron, aluminum, bronze etc. For example, in at least one embodiment, the metal plate can be a 1020 HRS, or RoHS steel with compliant zinc plating.

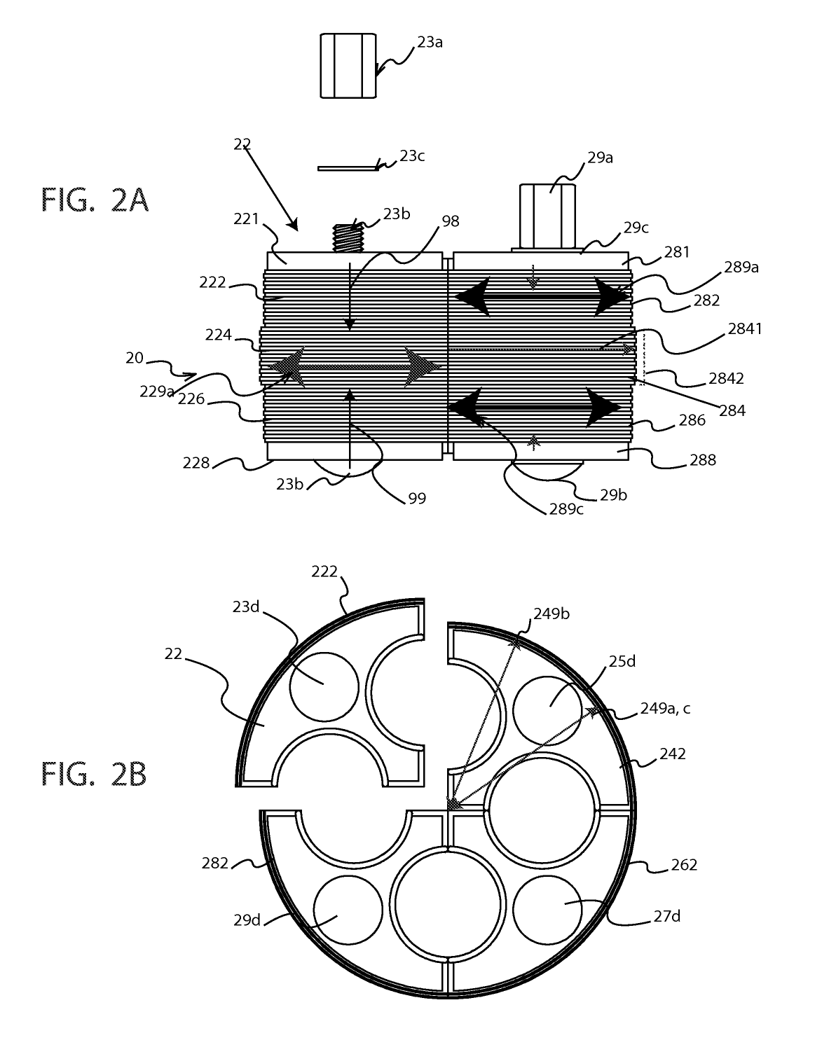

In addition, as shown in FIG. 1A, there are a plurality of nuts 23a, 25a, 27a, and 29a which are secured to bolts (See FIG. 2A) wherein these bolts and nuts are used to compress the two end plates together. The bolts can be made from any suitable material such as a metal. In at least one embodiment, the bolts are made from 304 stainless steel. In addition, an associated washer can also be made from any material, such as 304 stainless steel (See FIG. 2A and FIG. 2B), while the nut can be made from any material, such as 316 stainless steel.

Between these sections are openings 32, 34, 36 and 38 which are configured to receive wires or other type of cabling or any other type of tubular matter. In addition, as shown in FIG. 1B there are also gaps 31, 33, 35 and 37 between these plates as well. FIG. 1B shows an opposite view of this sealing system wherein an opposite set of plates 228, 248, 268, 288 are shown secured to the plates on the first side via a plurality of bolts as discussed above. Bolts 23b, 25b, 27b, and 29b in combination with the aforementioned nuts are configured to form a clamping system which is configured secure respective plates to each other. Therefore, each section 22, 24, 26, and 28 can be defined by the two plates on opposite sides of each other with a plurality of sealing elements, such as rubber gaskets, disposed in between. These rubber gaskets or sealing elements are shown in greater detail in FIGS. 2A-2B, 4A-4D, 5A-5C, 6, 7A-7D, and 8A-8E.

This view also shows gaps or openings 31, 33, 35 and 37 which are disposed between these sets of plates as well. When the plates are compressed together, the compressive force displaces the sealing element material expanding it outward as shown in FIG. 1C, and then expand out as shown by the arrows shown in FIG. 1C.

FIG. 1C shows an example of this sealing system being installed into a pipe or tube 100 wherein this sealing system 10 is then configured to be compressed by the tightening of these bolts and then cause the sealing elements to expand to fill any gaps in the holes or gap regions 31, 32, 33, 34, 35, 36, 37, and 38. The arrows 101 and 102 show that when the plates are compressed together, the sealing elements extend out radially. This is also shown in greater detail in FIG. 2A as well with arrows 229a, 289a and 289c, which causes expansion of these sealing elements in a lateral direction when they are compressed. As shown, these sections form a substantially circular cross section with each section forming a substantially equal ¼ portion. Each section forms approximately a ¼ turn around the circle.

In addition, arrows 103 and 104 also show that the sealing elements expand laterally into hole 34 to fill a gap inside of hole 34 to seal against an object, such as a cable. Arrows 105 and 106 show that the sealing elements are configured to compress together as well.

FIG. 2A shows a side view of the device which shows a nut 23a being removed from the sealing device with a washer 23c and an associated bolt 23b as well. There is also shown a nut 29a which is secured to bolt 29b and which compresses washer 29c as well. The compression of these sealing elements by the tightening of the nut on the bolt causes the plates to move together as shown by arrows 98 and 99 which causes extension or displacement of these sealing elements in a transverse direction as shown by arrows 229a, 289a and 289c.

The sealing elements disposed between these plates are such that there are at least three different sealing elements formed in layers extending from one plate to another plate. For example, in section 22 there is a first sealing element 222, a second sealing element 224, and a third sealing element 226. These sealing elements are disposed between plates 221, and 228. First sealing element 222 can be comprised of any suitable material, such as for example, rubber, plastic or any other suitable material that can be used. In at least one embodiment, the sealing elements can be made from EPDM rubber. In at least one embodiment, the two outer sealing elements 222 and 226 can be made from the same or substantially similar type material, such as EPDM rubber having a minimum tensile strength of 1500 psi and a minimum elongation of 475% and a minimum hardness per ASTM D2000 of 60+/−5.

The inner or middle sealing element can have a minimum tensile strength of 990 psi and a minimum elongation of 275% and a minimum hardness per ASTM D2000 of 40+/−5. The hardness and strength properties exhibited by the inner sealing element can be on the order of a ratio of approximately 1.5 to 1. The differences in properties between the two outer sealing elements 222 and 226 and the inner sealing element 224 can be attributed to a difference in the amount of carbon black associated with the EPDM rubber among other elements. Carbon black can be used as a reinforcing filler in rubber. Therefore, the two outer sealing elements 222 and 226 would have a higher level of carbon black than the inner sealing element 224. In addition, shown adjacent to section 22 is section 28 which includes end plates 281, and 288 with three sealing elements 282, 284 and 286 disposed in between. For example, sealing elements 282 and 286 are comprised of a first type of EPDM rubber such as that described for the first sealing element 222 while middle or second sealing element 284 is comprised of a second type of EPDM rubber such as that described for the second sealing element 224.

Even in an uncompressed state, middle or second sealing element 284 which is similar to middle or second sealing elements 224, 244, 264, extends radially out farther than adjacent sealing elements 282 and 286. This additional extension could be in the order of approximately 1%-10% of additional extension in terms of diameter, such as for example, 1%, 2%, 3%, 4%, 5%, 6%, 7%, 8%, 9% or even 10% of additional extension. Because of this additional extension, as shown by diameter line 2841 this middle or second sealing element can extend out farther to further seal the sealing device within a pipe. The extension is shown by dashed dotted line 2842.

FIG. 2B shows a partially unassembled version of the sealing systems shown in FIG. 1A. This view shows the lateral expansion of these sealing elements 222, 242, 262, and 282 in a lateral direction in the direction of arrows 249b and 249a and 249c.

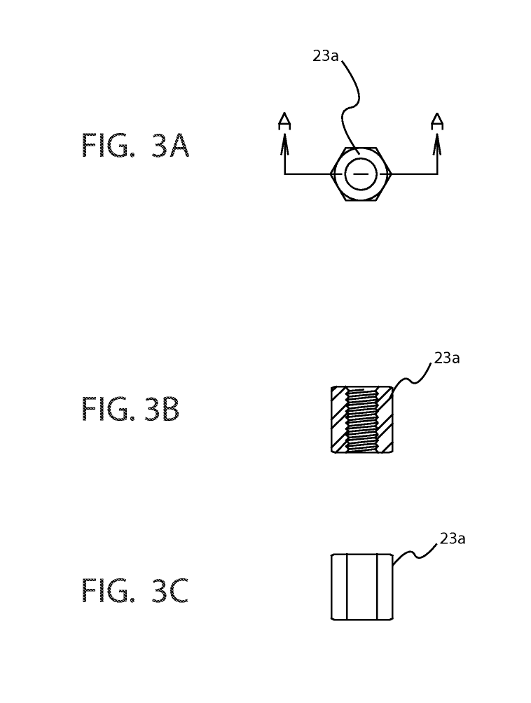

FIGS. 3A-3C show the different views for nut 23a including a top view, a side cross-sectional view and a side view as well. This view also shows the sections having additional holes 23d, 25d, 27d, and 29d respectively. These holes are larger holes which are configured to receive a larger clamp that can be used to clamp these sealing elements together.

These different sealing elements can be fit together such that the sealing elements fit in a compact and snug manner with the outer two sealing elements 222, and 226 nesting inside of recessed portions of the middle sealing element 224.

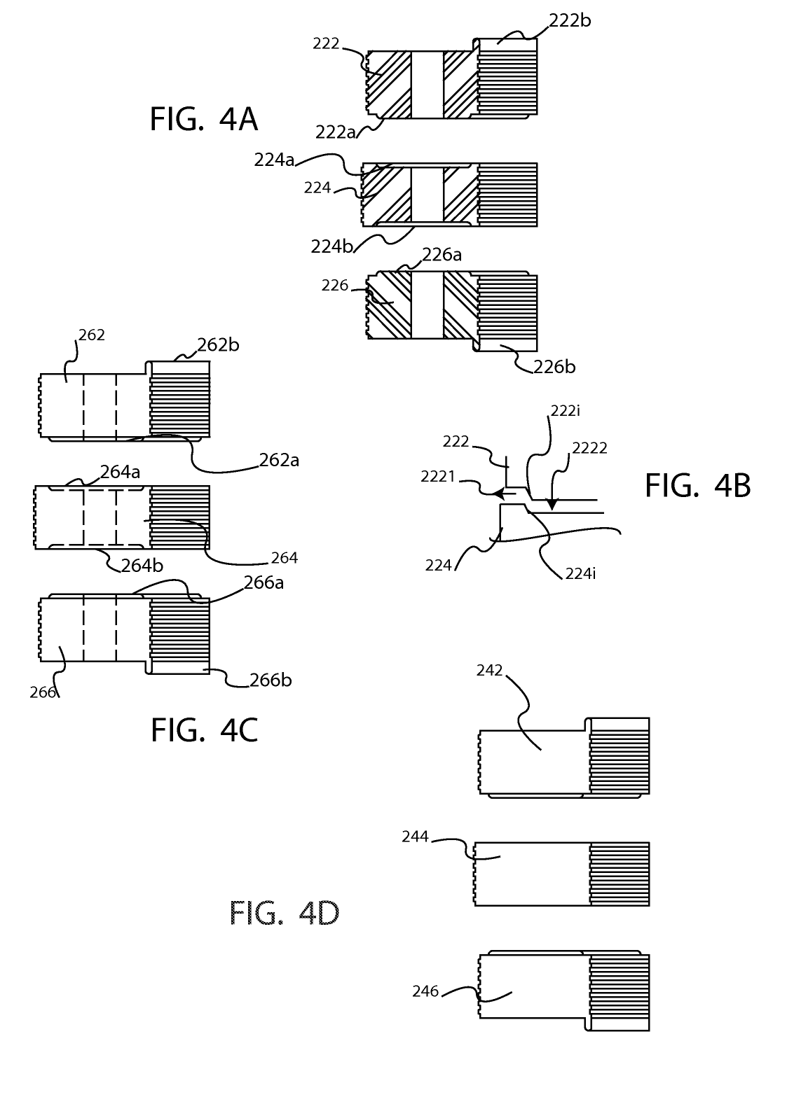

For example, as shown, FIG. 4A shows these sealing elements 222, 224, 226 which are shown positioned one on top of the other wherein sealing element 222 has a first protrusion section 222a and a second protrusion section 222b. Protrusion section 222b is configured to receive a plate. Sealing element 224 includes a recess 224a which is configured to receive protrusion 222a. In this way, protrusion section 222a is configured to nest or be positioned inside of recess 224a. Because this protrusion section 222a rests inside of recess 224a, when the sealing elements are compressed, it causes outer sealing elements 222 and 226 to compress middle sealing element 224 with the protrusion 222a also expanding out and pushing out on the walls of recess 224a. This effect is shown in greater detail in FIG. 4B, which shows arrows 2221 and 2222 indicating the lateral movement and pressure placed by sealing element 222 when pressed against sealing element 224. Arrow 2221 indicates the lateral displacement that is assisted by the intersection of protrusion 222a with recess 224a. Arrow 2222 shows the downward pressure provided by sealing element 222 on sealing element 224 as well. Accordingly, sealing element 224 has an interface 224i which is formed in the edge of the recess or indentation 224a, wherein this interface extends substantially transverse to a radial extension of the body of sealing element 224. In addition, sealing element 222 includes an interface 222i which extends substantially transverse to the radial extension of the body of sealing element 222. Thus with these transversely extending or substantially perpendicularly extending interfaces, the intersection of these interfaces causes sealing element 222 to press radially out on sealing element 224 during compression, thereby causing further lateral extension or displacement and sealing of any gaps in a pipe. Furthermore, sealing element 226 includes protrusion 226a while sealing element 242 includes indent 224b configured to receive protrusion 226a in a manner similar to protrusion 222a intersecting with indent 242a. Sealing element 226 also includes protrusion 226b which extends out to hold a plate such as plate 228 therein (see FIG. 1).

Because the hardness and tensile strength of sealing element 224 is less than the outer sealing elements 222, this causes sealing elements 222 and 226 to force further deformation of middle sealing element 224. Because the tensile strength of the sealing elements 222 and 226 are less than the outer plates, this allows for a more gradual deformation of the sealing elements and a more thorough sealing of the device than if the sealing elements were of all of the same hardness.

FIG. 4C shows sealing elements 262, 264, and 266 which include first and third sealing elements 262 and 266 respectively of a first material and a middle sealing element 264 of a second type of material. First and third sealing elements 262, and 266 have protrusions 262a, and 266a extending therefrom, while middle or second sealing element 264 has corresponding indents or recesses 264a and 264b configured to receive these protrusions. In addition, first and third sealing elements 262 and 266 each have protrusions 262b and 266b configured to lock in or contain sealing plates 261 and 268 as well.

FIG. 4D shows sealing elements 242, 244 and 246 which are configured in a manner similar to the respective sealing elements 262, 264, and 266 described above.

While the above disclosure in FIGS. 4A-4D show protrusions 222a and 226a and indents 224a and 224b, the connections and associated nesting could be reversed wherein sealing elements 222 and 226 could have indents and sealing element 224 could have protrusions.

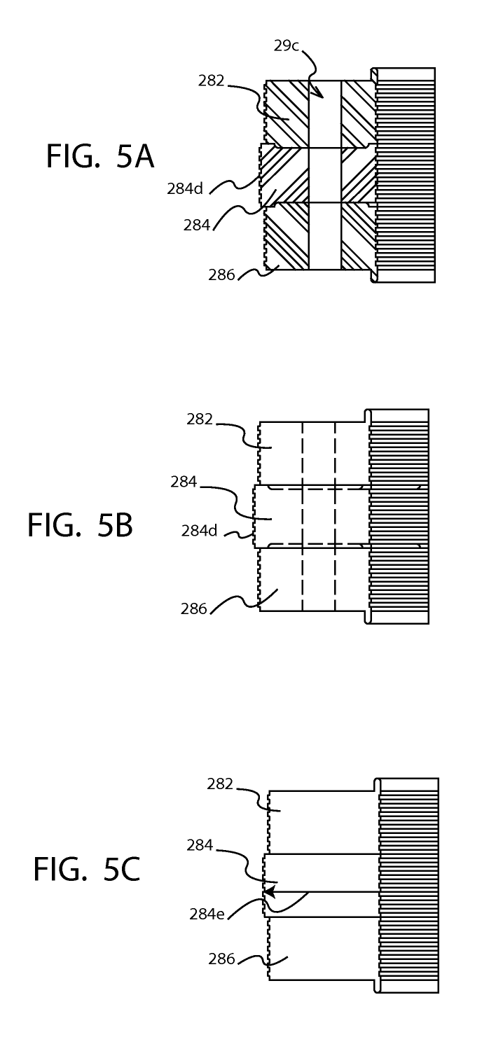

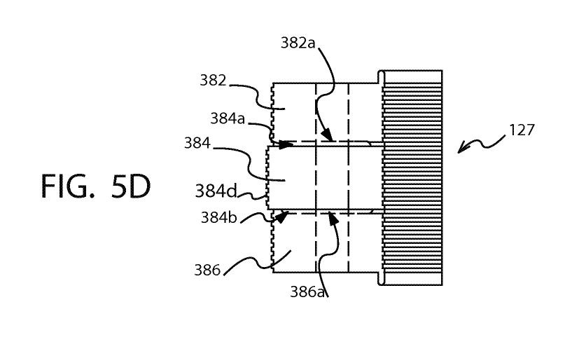

FIG. 5A shows a side cross-sectional view of an assembled section of the sealing system which shows sealing elements 282, 284, and 286 nesting inside of each other. In addition the outer surfaces of these sealing elements as shown by 284d shows that these outer surfaces are corrugated or rippled so that these outer surfaces can be more easily compressed against the outer wall of a tube or channel as shown in FIG. 1C. The different channels or opening 29c are also shown in this view.

FIG. 5B shows a side view of an assembled section of the sealing system showing hidden lines or passages which are also shown in FIG. 5A.

FIG. 5C shows a side view of this assembled section of the sealing system. Dimensionally, the inner sealing element 284 also has a larger radius than the two outer sealing elements 282, and 286. This is also shown by way of example by arrow 284e which shows the uncompressed extension of middle or inner sealing element 284 radially farther than, or outside of sealing elements 282 and 286.

FIG. 5D shows a side view of another embodiment which shows the intersection of the protrusions and indents in a reverse manner. In this design, inner or second sealing element 384 has protrusions 384a and 384b while the other two sealing elements comprising the first sealing element 382, and the third sealing element 386 have indentations 382a and 386a respectively. With this design, the compression force on these sealing elements still results in the lateral extension of second sealing element 384 of a section 127. Sealing section 384 includes protrusions 384d which extend laterally out to form a rippled surface or ridges.

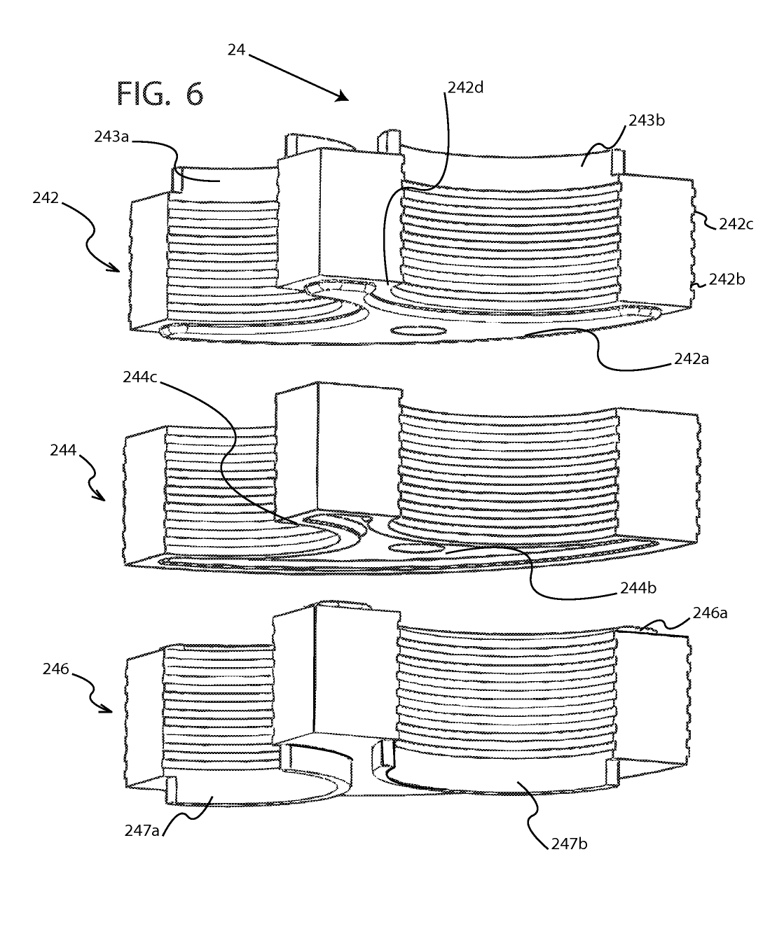

FIG. 6 shows a perspective exploded view of a section of the sealing system. This section 24 includes sealing elements 242, 244, and 246 which can be compressed together via the end plates. In this view, protrusion 242a is shown extending out from the bottom surface 242d. The sealing element includes a protrusion 243a and 243b configured to seal and secure plates such as plate 241 therein. These protrusions are similar to protrusions 222b, and 226b as well as protrusions 262b and 266b, as well as protrusions 282b and 288b as well. In addition this sealing element 242 includes additional protrusions 242c and indents 242d to form a rippled exterior. As discussed above, this protrusion fits inside of an indentation or recess 244a. In addition an opposite recess 244b is also shown which is configured to receive an oppositely positioned protrusion 246a. Sealing element 246 is shown having protrusions 247a and 247b which are configured to seal against holes 34 and 36 shown in FIG. 1A and also secure plates such as plate 248 therein.

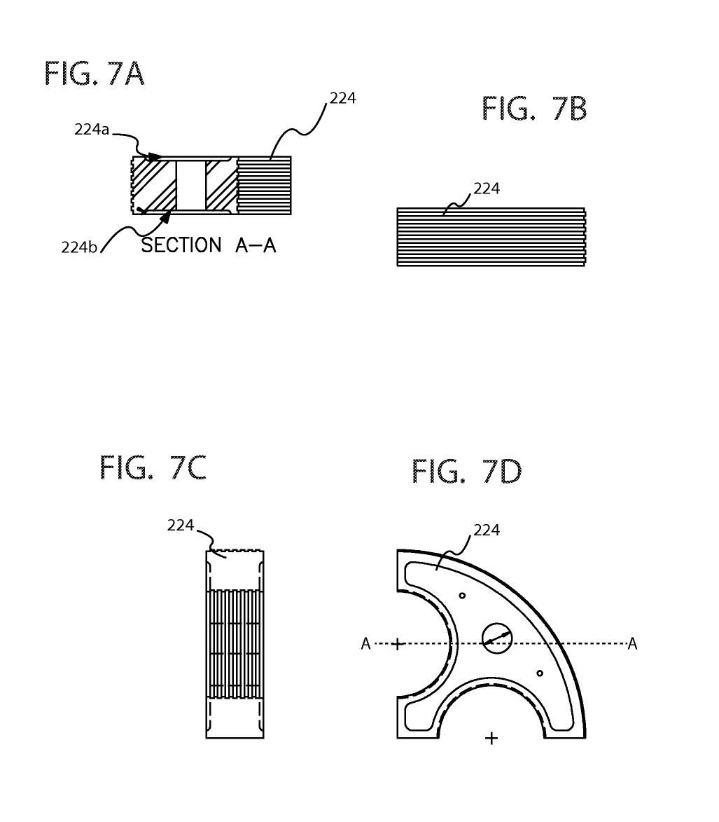

For example, FIG. 7A, is a side cross-sectional view taken along line A-A from FIG. 7D. FIG. 7B shows an outer view of sealing element 224, while FIG. 7C shows an inner view. FIG. 7D shows a side view showing cross-sectional line A-A.

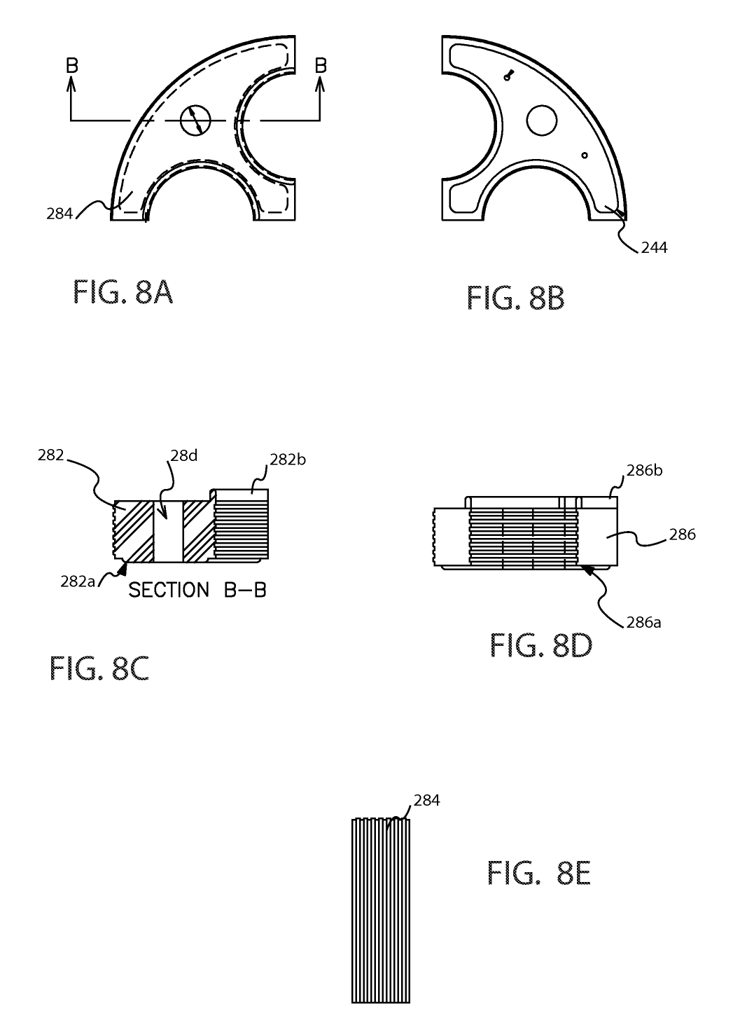

FIG. 8A shows a side view with line B-B extending through. FIG. 8B shows an opposite side view of sealing element 244. FIG. 8C shows the cross-sectional view taken along line B-B of sealing element 282 having hole 28d, with protrusions 282a and 282b. FIG. 8D shows a side view of sealing element 286 having protrusions 286a and 286b, while FIG. 8E shows an end view of sealing element 284.

Essentially, for each section 22, 24, 26 and 28 each of the components are substantially similar in that each section has two outer plates, and three inner sealing elements with an inner sealing element having a lower tensile strength and lower hardness than the two outer sealing elements. The inner sealing element also has a recess positioned on each side from which to receive protrusions from the two outer sealing elements. Dimensionally, the inner sealing element also has a larger radius than the two outer sealing elements as well as shown by way of example by arrow 284e which shows the uncompressed extension of middle or inner sealing element 284 radially farther than, or outside of sealing elements 282 and 286. This allows the inner sealing element to act as the primary sealing element to compress against an outer tube or pipe such as pipe or tube 100 shown in FIG. 1C. This allows further compression of the inner sealing element thereby insuring a proper seal of a conduit or pipe.

While some of the sections 22, 24, 26, and 28 are discussed in greater detail than other sections, in at least one embodiment, each of these sections have common elements described above, such that in at least one embodiment, the first and third sealing elements have a greater hardness than the second or middle sealing element such that in at least one embodiment the ratio for hardness between these sealing elements is approximately 1.5 to 1.

With the design described above, there can be a process for sealing an opening in a pipe comprising the steps of inserting a plurality of sections such as sections 22, 24, 26 and 28 into a channel or tube 100 wherein each section is approximately ¼ turn around the circular cross section. Each section comprises a first end bracket 221, 241, 261, 281 comprising a metal; a second end bracket 228, 248, 268, 288 comprising a metal; a plurality of sealing elements 222, 224, 226; 242, 244, 246; 262, 264, 266; 282, 284, 286 disposed between the first respective end bracket and the second end bracket.

The a first sealing element has a protrusion the second sealing element 222, 242, 262, 282 has a first face having an indentation disposed therein 224a, 244a, 264a, 284a, and a second face having an indentation disposed therein 224b, 244b, 264b, 284b a third sealing element having a protrusion 226a, 246a, 266a, 286a; wherein the first sealing element has a first hardness, the second sealing element has a second hardness, and the third sealing element has a hardness different than the hardness of the second sealing element and is substantially similar in hardness to the first sealing element clamping the first end bracket and the second end bracket together to compress the plurality of sealing elements together.

In at least one embodiment, the step of clamping creates displacement of the second sealing element 224, 244, 264, 284, in a lateral direction, which is transverse to a direction of clamping. In at least one embodiment, the first sealing element 222, the second sealing element 224, and the third sealing element 226 are displaced in a lateral direction substantially transverse to a direction of clamping of the first end bracket 221 and the second end bracket 281. In at least one embodiment, the second sealing element 224 is displaced to a greater extent than the first sealing element 222 and the third sealing element 226. This creates a substantially fluid tight seal sealing a first portion of a channel or pipe 100 from a second portion of the channel or pipe 100 thereby insulating the second end of the channel or pipe from any outside influence.

Accordingly, while at least one embodiment of the present invention has been shown and described, it is to be understood that many changes and modifications may be made thereunto without departing from the spirit and scope of the invention as defined in the appended claims.

What is claimed is:

1. A sealing system comprising:
a) a first end bracket;
b) a second end bracket; and
c) a plurality of sealing elements disposed between said first end bracket comprising:
i) a first sealing element extending along a first radius;
ii) a second sealing element extending along a second radius; and
iii) a third sealing element;
wherein said first sealing element has a first hardness, said second sealing element has a second hardness, and said third sealing element has a hardness different than said hardness of said second sealing element; and wherein said second radius of said second sealing element is a larger radius than said first radius of said first sealing element.

2. The sealing system as in claim 1, wherein said second sealing element has a larger radius than said third sealing element.

3. The sealing system as in claim 2, wherein said second sealing element has at least two sides with a first side positioned adjacent to said first sealing element and a second side positioned adjacent to said third sealing element, wherein said first side has at least one indented portion configured to receive said first sealing element.

4. The sealing system as in claim 1, wherein the second sealing element is dimensioned such that when the first sealing element, the second sealing element and the third sealing element are positioned adjacent to each other, the second sealing element has an outer perimeter surface that extends out radially farther than the first sealing element and the second sealing element.

5. The sealing system as in claim 1, wherein said first sealing element and said second sealing element have a hardness ratio of approximately 1.5 to 1.

6. The sealing system as in claim 1, wherein an outer peripheral region of at least one of said first sealing element, said second sealing element and said third sealing element are rippled.

7. The sealing system as in claim 1, further comprising at least one clamp configured to compress said first sealing element and said third sealing element together with said second sealing element.

8. The sealing system as in claim 7, wherein said first sealing element has a protrusion, and said second sealing element has an indentation configured to receive said protrusion of said first sealing element.

9. The sealing system as in claim 8, wherein said indentation of said second sealing element has a surface configured to receive a surface of said protrusion of said first sealing element such that when said first sealing element and said third sealing element are compressed, it presses radially out on said surface of said indentation of said second sealing element to cause radial expansion of said second sealing element.

10. A sealing system for a pipe comprising a body section having a substantially circular cross section, the sealing system comprising:
a) a plurality of sections, wherein each section is approximately ¼ turn around the circular cross section, wherein each section comprises:
i) a first end bracket comprising a metal;
ii) a second end bracket comprising a metal;
iii) a plurality of sealing elements disposed between said first end bracket and said second end, comprising:
A) a first sealing element having a protrusion;
B) a second sealing element having a first face having an indentation disposed therein, and a second face having an indentation disposed therein;
C) a third sealing element having a protrusion;
wherein said first sealing element has a first hardness, said second sealing element has a second hardness, and said third sealing element has a hardness different than said hardness of said second sealing element and is substantially similar in hardness to said first sealing element;
b) a clamp configured to clamp said first end bracket, said second end bracket and said plurality of sealing elements together such that when clamped, said protrusion of said first sealing element presses into said indentation on said first face of said second sealing element and said protrusion of said third sealing element presses into said indentation of said second face of said second sealing element such that said indentation of said first sealing element and said indentation of said third sealing element press radially out on said second sealing element causing said second sealing element to extend radially out to create a sealing effect on the pipe.

11. The sealing system as in claim 10, wherein said second sealing element has a larger radius than said first sealing element.

12. The sealing system as in claim 11, wherein said first sealing element and said second sealing element have a hardness ratio of approximately 1.5:1.

13. The sealing system as in claim 10, wherein said protrusion of said first sealing element has a face that extends transverse to a radial extension of a body of said first sealing element, and wherein said indentation of said second sealing element has a face that extends transverse to a radial extension of a body of said second sealing element.

14. The sealing system as in claim 13, wherein said face of said first sealing element and said face of said second sealing element are configured to be coupled adjacent to each other such that when a section of said plurality of sections is compressed by said clamp, it causes said face of said first sealing element to press radially out on said face of said second sealing element to cause said second sealing element to extend out laterally to seal the pipe.

15. A process for sealing an opening in a pipe, comprising the steps of:
inserting a plurality of sections, into a channel wherein each section is approximately ¼ turn around the circular cross section, wherein each section comprises:
i) a first end bracket comprising a metal;
ii) a second end bracket comprising a metal;
iii) a plurality of sealing elements disposed between said first end bracket and said second end comprising:
A) a first sealing element having a protrusion;
B) a second sealing element having a first face having an indentation disposed therein, and a second face having an indentation disposed therein;
C) a third sealing element having a protrusion;
wherein said first sealing element has a first hardness, said second sealing element has a second hardness, and said third sealing element has a hardness different than said hardness of said second sealing element and is substantially similar in hardness to said first sealing element;
clamping said first end bracket and said second end bracket together to compress said plurality of sealing elements together.

16. The process as in claim 15, wherein said step of clamping creates displacement of said second sealing element in a lateral direction, which is transverse to a direction of clamping.

17. The process as in claim 16, wherein said first sealing element, said second sealing element and said third sealing element are displaced in a lateral direction substantially transverse to a direction of clamping of said first end bracket and said second end bracket.

18. The process as in claim 17, wherein said second sealing element is displaced to a greater extent than said first sealing element and said third sealing element.
